(19) United States
(12) Patent Application Publication
(10) Pub. No.: US 2013/0204694 A1
(43) Pub. Date: Aug. 8, 2013

(54) Context-Based Study Generation and Administration

(71) Applicants: James A. Banister, Park City, UT (US); Michael P. Dowling, Santa Monica, CA (US); Matthew A. Pelletier, Van Nuys, CA (US); Heather E. Finney, Park City, UT (US); Hamza Kubba, Montreal (CA)

(72) Inventors: James A. Banister, Park City, UT (US); Michael P. Dowling, Santa Monica, CA (US); Matthew A. Pelletier, Van Nuys, CA (US); Heather E. Finney, Park City, UT (US); Hamza Kubba, Montreal (CA)

(73) Assignee: SAYSO, LLC, Santa Monica, CA (US)

(21) Appl. No.: 13/367,665

(22) Filed: Feb. 7, 2012

(51) Int. Cl. G06Q 30/02

(52) U.S. Cl. 705/14.41

(57) ABSTRACT

A method for delivering a context-based study to a panel in order to measure the effectiveness of advertisements is provided. One disclosed method may include receiving a study definition from a study generation device, the study definition including panel criteria and a target context, and selecting a panel of panelist candidates by matching the panel criteria with panelist candidate demographic information. The method may include monitoring browser events via a study client browser extension of a panelist computing device in order to determine when a target context has been met. The method may further include sending a report indicating that the target context has been met.

### BACKGROUND

Measuring the effectiveness of advertisements displayed on a web page ensures that an advertiser is reaching customers successfully and that potential customers are experiencing content that is relevant and desirable. However, current methods to measure effectiveness of advertisements provide usage statistics from the point-of-view of the advertisement, merely measuring events occurring to the advertisement. Such methods of effectiveness measurement provide incomplete reports regarding success or failure of an advertisement, as there is no context provided for the usage statistics, and therefore no direction provided for improving the evaluated advertisement. This leads to lost time and money for advertisers and frustration for potential customers, as advertisers blindly develop alternate advertisements or choose alternate web pages on which to include their advertisements, without pertinent information to guide their selections. Additionally, usage statistics may skew undesirably and provide misleading results, as measured interactions with an advertisement may originate from compromised computing devices or a one-time influx of a certain group of potential customers who would not normally visit a particular web page.

### SUMMARY

Methods for administering a computerized study to a plurality of panelists are provided. One disclosed method may include selecting a panel of panelists by matching panel criteria for a study with demographic information received by each of the panelists. The method may include sending to the computing devices of the selected panelists a study client program and a target context, the study client program being a browser extension configured to monitor browser events to determine if the target context has been met. The method may further include receiving from the computing devices of the selected panelists a report indicating that the target context has been met.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a system for administering a computerized study to a plurality of panelists, according to one embodiment.

FIG. 2 is a schematic diagram illustrating a panelist computing device of the system of FIG. 1.

FIG. 3 is a schematic diagram illustrating the system of FIG. 1, in a use case scenario in which the panelist computing device is participating in a computerized study testing ad effectiveness.

FIG. 4 is a schematic diagram illustrating the system of FIG. 1, in a use case scenario in which the panelist computing device is participating in a computerized study performing ad pretesting.

FIG. 5 is a schematic diagram illustrating the system of FIG. 1, in a use case scenario in which the panelist computing device is participating in a computerized study performing behavioral tracking.

FIG. 6 is a schematic diagram illustrating the system of FIG. 1, in a use case scenario in which the panelist computing device is participating in a computerized study including a survey.

FIG. 7 is a schematic diagram illustrating an exemplary web page appearing within a browser of the panelist computing device executing a client study program in the system of FIG. 1.

FIG. 8 is a communication flow diagram illustrating exemplary communications between the components of the system of FIG. 1.

FIG. 9 is a diagram illustrating exemplary communications between the components of the system of FIG. 1, when administering a computerized study of ad effectiveness.

FIG. 10 is a diagram illustrating exemplary communications between the components of the system of FIG. 1, when administering a computerized study performing ad pretesting.

FIG. 11 is a diagram illustrating exemplary communications between the components of the system of FIG. 1, when administering a computerized study performing behavioral tracking.

FIG. 12 is a diagram illustrating exemplary communications between the components of the system of FIG. 1, when administering a computerized study including a survey.

### DETAILED DESCRIPTION

Aspects of this disclosure will now be described by example and with reference to the illustrated embodiments listed above.

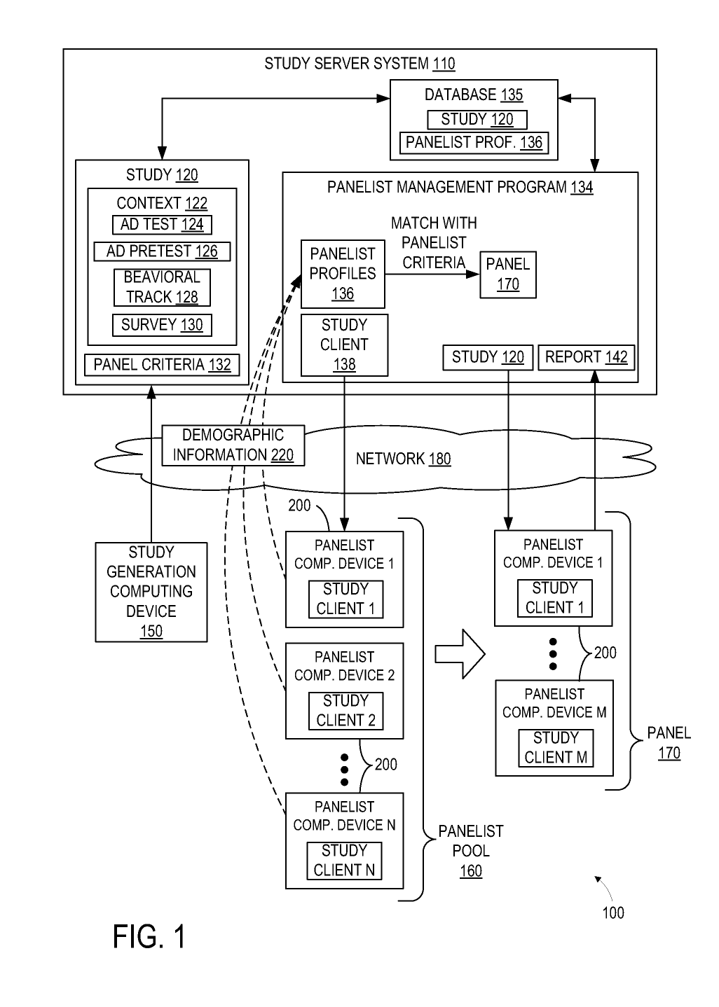

FIG. 1 illustrates a system 100 for administering a computerized, context-based study to a plurality of panelists. The system 100 may include a study server system 110, which is connected through a computer network 180, such as the Internet, to study generation computing device 150 and a plurality of panelist computing devices 200 from a panelist pool 160. Study server system 110 may receive from study generation computing device 150 a study definition 120, defining target context 122 to be met and the panel criteria 132 to be used to filter panelist pool 160. The study definition 120 may be stored in a database 135 associated with the study server system 110 and may be stored on panelist computing device 200, for instance during an operation to programmatically sync data between the panelist computing device 200 and the study server system 110.

Study server system 110 may receive from each panelist computing device 200 in panelist pool 160 information such as demographic information to construct panelist profiles 136 and may send to each panelist computing device in panelist pool 160 a study client program 138. This may occur during a registration period, during which a panelist registers with panelist management program 134 of study server system 110. The panelist profiles 136 may also be stored in the database 135 for later access. Study server system 110 may then match the information from panelist profiles 136 with panel criteria 132 in order to form a panel 170 of selected panelists to which the study 120 may be distributed.

Study server system 110 may then send target context 122 from study definition 120 to the selected panelist computing devices of panel 170 and receive a report 142 from each panelist computing device of panel 170 when the contexts of the study have been met. Target context 122 may include one or more browser events to be detected, and may be determined to have been met if all browser events identified in target context 122 are detected by study client program 138, or if a specified number of browser events identified in target context 122 are detected by study client program 138. These detected events may be reported to the server study system 110 and may be stored in database 135 within the panelist profile 136, to thereby augment the panelist profile for a more complete understanding of each panelist.

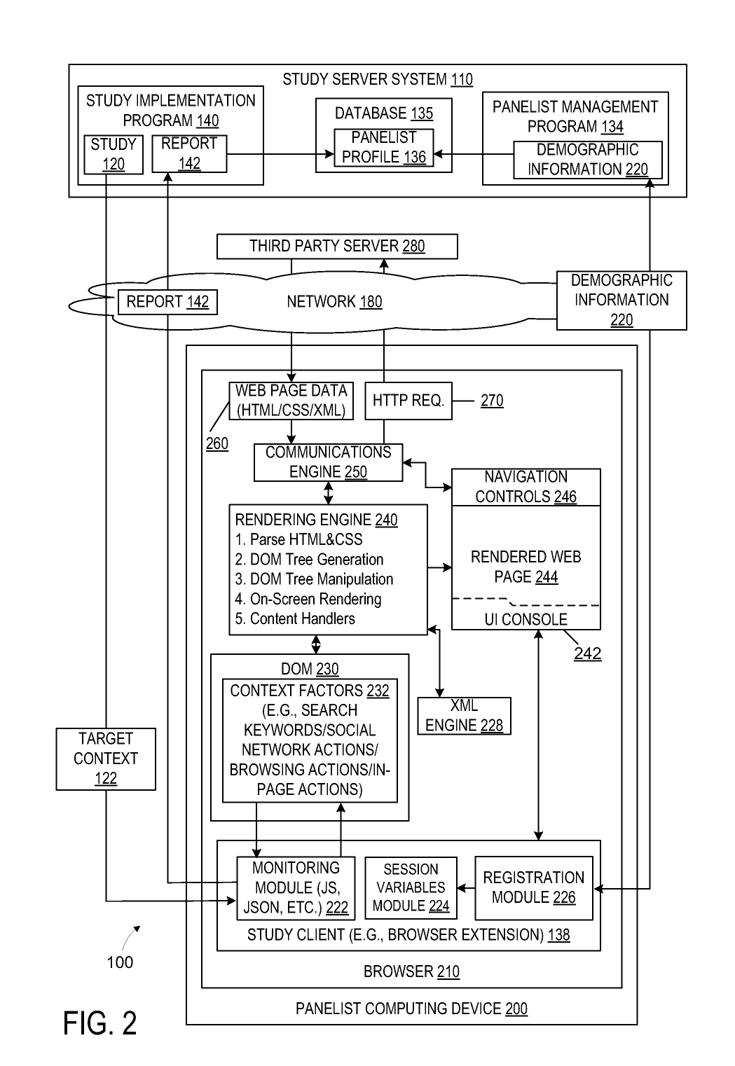

FIG. 2 illustrates a panelist computing device 200 as an exemplary panelist computing device of panel 170 shown in FIG. 1. Panelist computing device 200 may contain a browser 210 to allow a panelist to visit and view various web pages over network 180. A panelist using panelist computing device 200 may wish to register with study server system 110 by sending demographic information 220 to include in a panelist profile 136 identifying the panelist. This demographic information may include an email address of the panelist. In other embodiments, the demographic information may include information about the panelist including age, gender, location, ethnicity, familial status, etc. While in the depicted embodiment the demographic information 220 is uploaded during a registration phase, in other embodiments it may be sent separately from the registration request. In addition to demographic information 220, the panelist profile 136 may be augmented to include tracked behavioral data and other information received over time in one or more reports 142 from the study client 138. The panelist profile 220 thus may be augmented and modified over time within database 135. In some embodiments, study client program 138 may be sent from panelist management program 134 of study server system 110 in the form of a browser extension to be installed and executed on panelist computing device 200.

Study client program 138 may include a monitoring module 222 encoded in JavaScript, JSON, JSONP, JQUERY, or other programming language. The monitoring module includes instructions configured to monitor browser events of panelist computing device 200. The study client program 138 further includes a session variables module 224 and registration module 226, which function as described below. Study client program 138 may also generate a user interface console 242, allowing a panelist to interact directly with study client program 138. User interface console 242 may be displayed by a display device of the panelist computing device, and may appear within a window of browser 210 as a web page or iFrame, or may be pinned to an edge of a window of browser 210, appearing if a panelist selects or moves a cursor over the associated edge.

Upon registering panelist computing device 200, panelist management program 134 of study server system 110 may send session variables to registration module 226 for use in validation routines. If it is determined that panelist profile 220 matches panel criteria 132 of study definition 120, target context 122 may be sent to monitoring module 222 of study client program 138 in order to provide target browsing events to be monitored by study client program 138.

When the panelist sends a web page request 270 from a third-party server 280, web page data may be sent to communications engine 250, then passed to rendering engine 240. Rendering engine 240 may parse the web page data 260, generate a Document Object Model (DOM) 230 tree from the parsed web page data, manipulate the DOM 230 tree in order to track the target context 122 amongst context factors 232, and display a rendered the web page 244 on a display device of the panelist computing device 200. Once monitoring module 222 detects that target context 122 has been met, monitoring module 222 may send a report 142 to panelist management program 134 of study server system 110, indicating that target context 122 has been met. The report may also contain details regarding the specific events that were tracked at the study client 138.

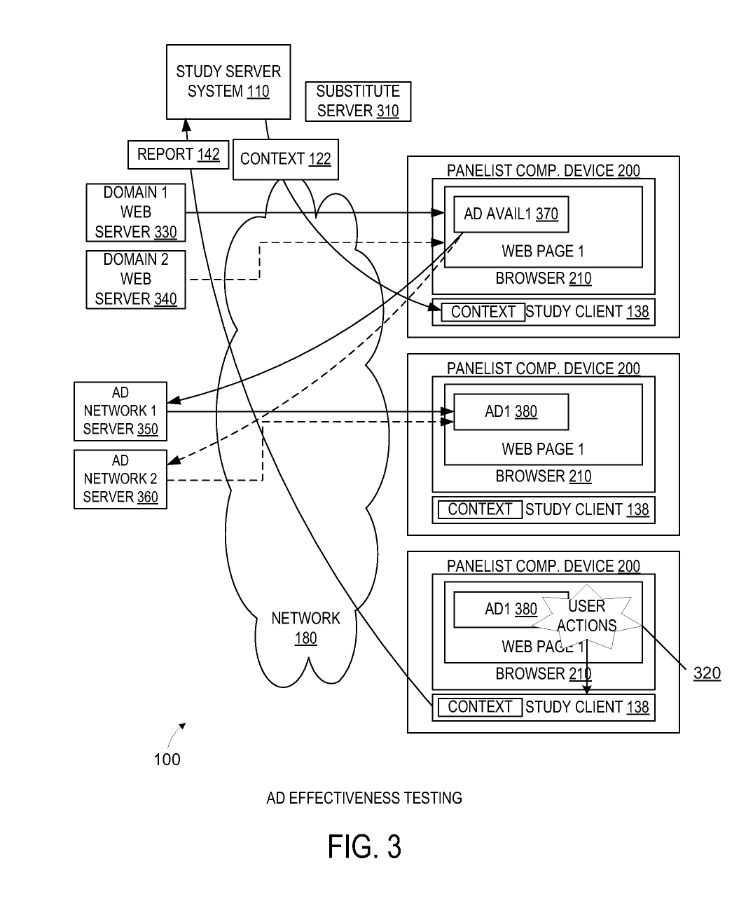

FIG. 3 illustrates a use case scenario of system 100 in which a panelist computing device 200 is participating in a first embodiment of a study in which the effectiveness of a targeted or targeted ads are tested. In this embodiment, context 122 may be sent from study server system 110, and may include an identifier for a target advertisement, such as an ad tag or ad network server to be tracked, as well as behavioral tracking information indicating browsing events and/or behavior such as page views, search engine behavior and social activity to be tracked.

Additionally, context 122 may include information indicating interactions with the target ad to be tracked, such as click-throughs (wherein the panelist ends up on a site targeted by, i.e., linked from the ad), time-on-page, ad engagement that does not result in a click-through (such as view or mouseover without click-thru), and interactivity with one or more competing ads. When web page data from a first domain web server 330 indicates a first ad avail 370 for an ad 380 from a first ad network server 350, the ad 380 may be requested from the first ad network server 350 and loaded into the first ad avail 370. Study client program 138 may then track user actions 320 and determine if context 122 is met. The process may repeat with each web page request, loading ads into ad avails and tracking user actions. Upon determining that context 122 has been met, study client program 138 may send report 142 to study server system 110 as an indication that context 122 has been met.

Further, it will be appreciated that the ad avail 370 may be serviced by either a first web server 330 at a first domain, or a second web server 340 at a second domain, and the ad 380 itself may be served by a first ad network 350 or a second ad network 360. In this manner, the study client program may be used to monitor context 122 across domains and across ad networks.

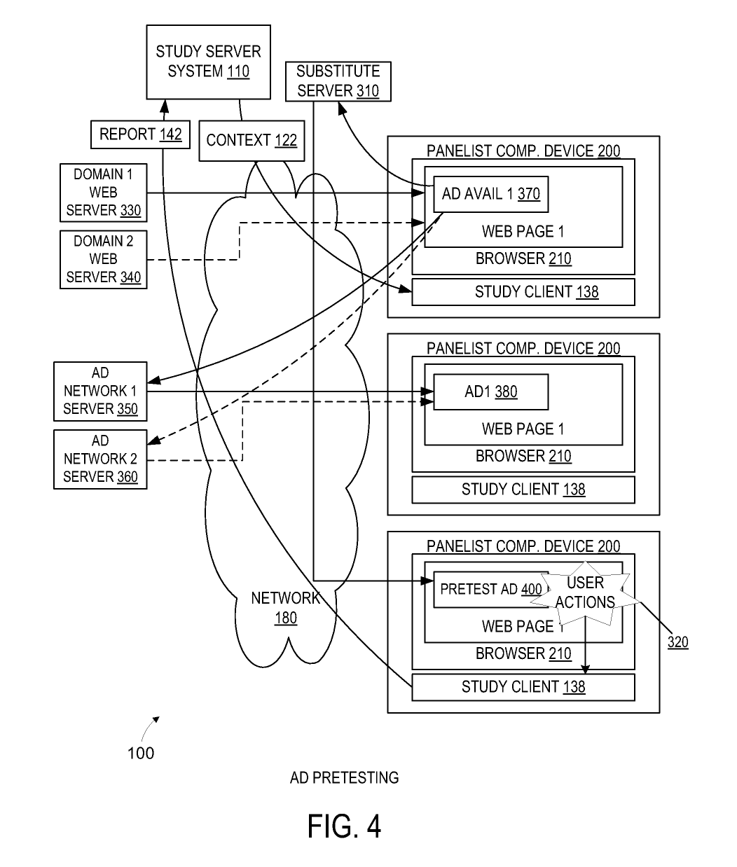

FIG. 4 illustrates the system 100 in a use case scenario in which a panelist computing device 200 is participating in a second embodiment of a study in which an advertisement is pretested by replacing one or more targeted ads with one or more pretest advertisements 400. In this embodiment, first the browser 210 executed on the panelist computing device 200 downloads the web page 1. Within the web page 1, an ad avail 370 is present, and the browser accordingly traverses a link to a first ad network server 350, downloads the Ad1 380, and renders the Ad1 380 in the ad avail1 370. Thereafter or concurrently, the study client 138 is loaded. The study client 138 requests target context 122 from study server system 110, and in response the study server system 110 sends the context 122 to the requesting study client 138. The target context 122 may include target behavioral tracking information indicating behavior such as page views, search engine behavior and social activity to be tracked by the study client 138 at the panelist computing device 200. The target context 122 may also include a URL or other designation, which the study client 138 may rewrite to be included in the web page, to cause the browser to send a request to a substitute server for pretest advertisement 400. Additionally, target context 122 may include information indicating interactions with the pretest ad 400 to be tracked, such as click-throughs (wherein the panelist ends up on a site targeted by the pretest ad 400), time-on-page, engagement with pretest ad 400 that does not result in a click-through, and interactivity with one or more competing ads. It will be appreciated that the context 122 may be downloaded at an earlier stage, prior to downloading of the web page, in some implementations.

After the context 122 is downloaded, the study client 138 modifies the web page in one of the following ways. As one option, the web page may be modified to replace displayed ad 380 with a pretest ad 400. To do this, the study client 138 rewrites the web page with a new link pointing to a pretest ad 400 on the substitute server 310. This causes the browser to traverse the link, send a request to the substitute server for the pretest advertisement 400, receive the pretest advertisement 400 from the substitute server, and display the pretest advertisement 400 in the ad avail 370 where the original ad 380 was previously displayed. As another option the study client 138 may be configured to create a new ad avail within the web page and display the pretest ad 400 in the newly create ad avail. As yet another option, the study client 138 may be configured to rewrite the web page in a manner that causes the browser 210 to forgo downloading the ad 380 and instead directly download the pretest ad 400 for display within the ad avail 370 without first downloading the ad 380. Study client program 138 may then track user actions 320 and determine if target events within context 122 have been met. Upon meeting the target events defined within context 122, study client program 138 may send report 142 to study server system 110 indicating the context has been met. The report may also include details of the specific events detected at the study client 138. This information may be added to the panelist profile by the server study system 110.

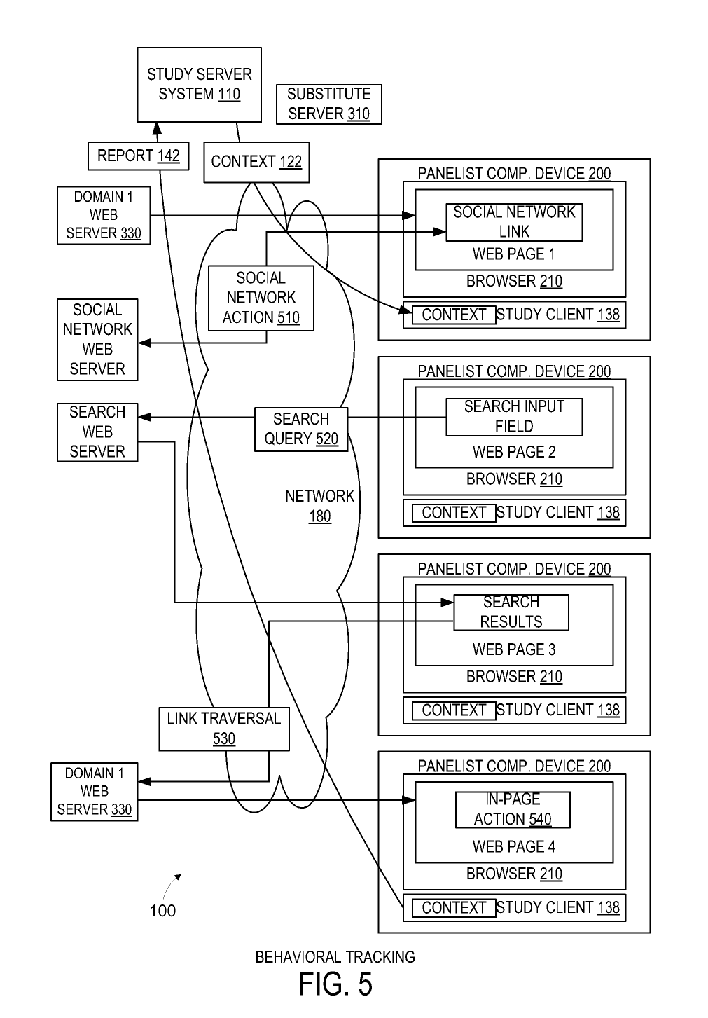

FIG. 5 illustrates the system 100 in a use case scenario in which a panelist computing device 200 is participating in a third embodiment of a study in which specified panelist behaviors are tracked. In this embodiment, context 122 may be sent from study server system 110 and may include information pertaining to relevant behaviors to track. These behaviors may include, but are not limited to, social network actions and behavior 510, such as a status update, a “like,” a location “check-in,” or a comment; search behavior or queries 520 such as keywords searched, search engines utilized, and search frequency; and various browsing navigation and in-page actions and behavior 540, such as number and frequency of sites visited, time on a site, referrals to and from sites including link traversal 530, etc. All behaviors may be monitored, and if context 122 is met, report 142 may be sent to study server system 110 as an indication, and details of the behaviors may also be included within the report and stored in the panelist profile at the study server system 110. It will be appreciated that the detection of these types of panelist behaviors may be used in combination with ad effectiveness testing and ad pretesting of FIGS. 3-4, to provide a desired social, search, browsing or in-page behavioral context for matching.

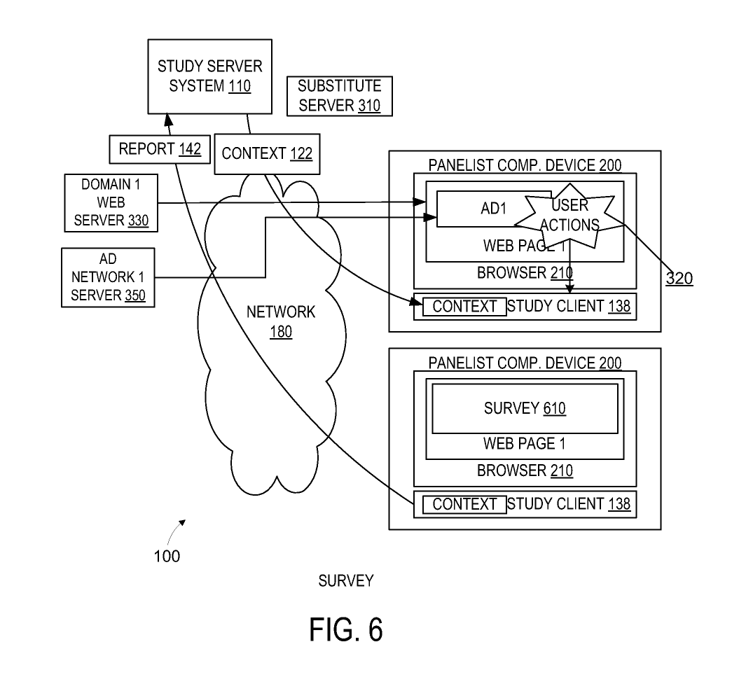

FIG. 6 illustrates the system 100 in a use case scenario in which a panelist computing device 200 is participating in a fourth embodiment of a study in which a survey is presented to the panelist in order to gather qualitative data regarding the panelist and his/her behaviors, opinions, intentions, etc. In this embodiment, context 122 may be sent from study server system 110 and may include information relating to relevant behaviors to track and/or targeted advertisements to track. When context 122 is determined to have been met by study client program 138, a survey 610 may be displayed so that the panelist may provide responses. The survey 610 may be inserted into a web page, slide out from an edge of browser 210, be delivered through a toolbar of browser 210, be displayed as a pop-up window or new tab of browser 210, or be presented to the panelist in any other suitable fashion. The survey 610 may be in the form of a poll, questionnaire, quiz, etc. The panelist may fill in the survey 610 and submit it to the study server system 110 in the form of report 142. It will be appreciated that the study described above may be delivered in combination with the ad effectiveness testing, ad pretesting, and behavioral tracking of FIGS. 3-5.

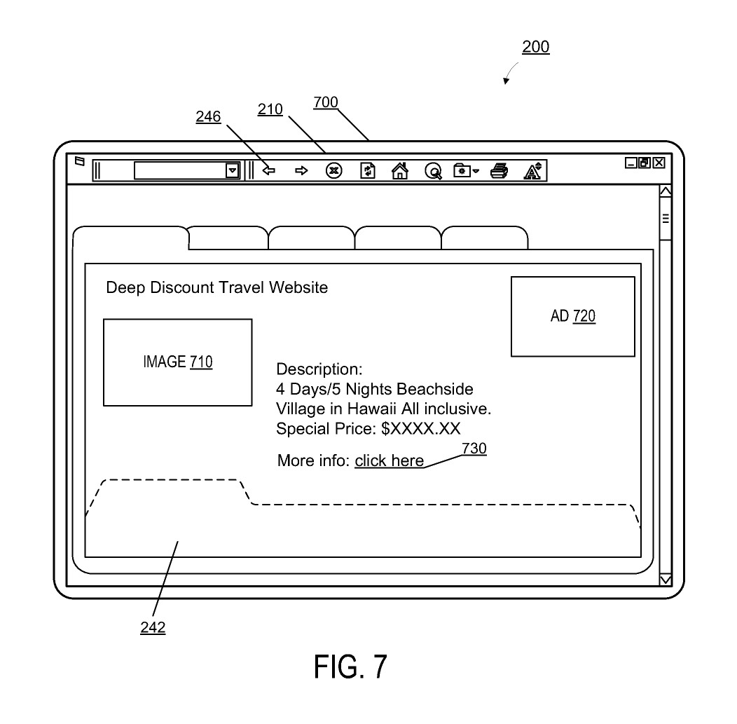

In FIG. 7, an exemplary web page appearing within a browser 210 of panelist computing device 200 is shown as it is displayed on display device 700 of panelist computing device 200. The browser includes navigation controls 246 and user interface console 242 for study client program 138, as well as web page elements including text, image 710, advertisement 720, and hyperlink 730, all of which can be monitored by study client program 138. Interactions with any of the aforementioned elements, including navigation controls 246 and user interface console 242 may be recorded as browser events and matched with target context 122.

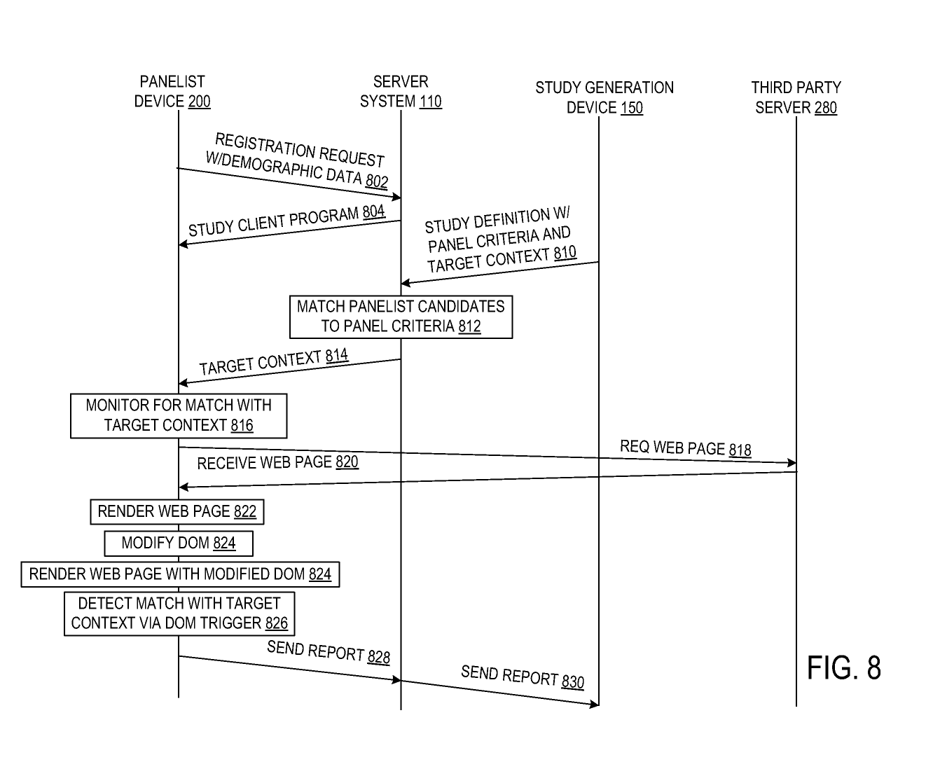

FIG. 8 illustrates exemplary communications between components of the system 100 for administering a study to a plurality of panelists. First, a registration phase begins in which a plurality of panelist candidates, having associated panelist computing devices, such as panelist device 200, register with server system 110. In step 802, a request is sent from panelist device 200 to server system 110, including demographic information identifying the panelist. This demographic information may include an email address associated with the panelist. In other embodiments, the demographic information may include information about the panelist including age, gender, location, ethnicity, familial status, etc., and in some embodiments may be sent with or separately from the registration request. It will be appreciated in one embodiment in the registration phase only a user email may be received as demographic information, and subsequently additional demographic information may be gathered through surveys and tracked behavioral data. It will be noted that demographic information may be derived from such tracked behavioral data. In this manner, the demographic information and behavioral data may both be collected and used to augment the profile 136 of the panelist over time. In response, at step 804, server system 110 sends study client program 138 to panelist device 200, in the form of a browser extension to be installed on panelist device 200. In alternative embodiments, study client program 138 may be sent from an alternative server system. It will be appreciated that the registration request at 802 and study client program response at 804 are performed for each of the plurality of panelist devices 200 in the panelist pool 160, described above.

Once study client program 138 is received, it may be installed on panelist computing device 200 by restarting the browser 210, refreshing a web page, or other appropriate method. After installing, study client program 138 may be configured to execute on each page load, which may include loading or refreshing a web page or iFrame or opening a new window or tab of browser 210. Upon detecting a page load, study client program 138 may be configured to validate by checking for cross-domain session variables from session variables module 224 which can be stored in a cross-domain cookie of panelist computing device 200. These session variables from session variables module 224 may include a candidate ID, candidate session ID, app ID and app authentication key, and may be used to load a specific instance of study client program 138, such as an “app” on a smartphone, as identified by the session variables of session variables module 224. In this manner, behavior, advertisements, and ad avails may be tracked across domains, and across browsing sessions open in different browser tabs, and across different iFrames (each having their own DOM) which may be included in a web page.

The study client program may also be configured to identify and authenticate a plurality of panelists on a single panelist computing device. For example, on first opening a browser, the study client program may request that a user confirm the user's identity via the console described above. In this manner, the study client program may authenticate and activate an appropriate configuration of study client program 138 by identifying and assigning session variables of session variables module 224 with the user who has logged in. This allows different panelists utilizing the same panelist computing device 200 and browser 210 to implement study client program 138 and ensure that monitored events are associated with the appropriate panelist, and likewise with an appropriate unique panelist ID.

The study client program 138 may therefore store session variables using session variables module 224, which may be sent to server system 110 in order to validate the session for the authenticated panelist. These session variables may include a panelist ID and a session ID for the active session, which identifies the user panelist and session to the server system 110. Upon validation, server system 110 may send data pertaining to the authenticated panelist using study client program 138 so that the data may be used to monitor events for context match on panelist computing device 200.

Either before, during, or after the registration phase described above, the method may include a study generation phase. In this phase, at step 810, study generation computing device 150 sends a study definition to server system 110, including panel criteria 132 to choose panelists and target context 122 to be met. The panel criteria may include information to create panel 170, such as demographic information and/or tracked behavioral data used to define characteristics of panelists in which a study generator is interested, and parameters to be applied when creating panel 170. These parameters may include, but are not limited to, a size of the panel 170, a quota or minimum threshold of demographic groups to be met, and a time limit on the study. Target context 122 may include one or more contextual factors used to perform any combination of behavioral measurement, ad effectiveness testing, and ad pretesting. By creating such a study definition, studies including ad effectiveness testing, ad pretesting, behavioral tracking, study, and combinations thereof may be implemented, as described above.

In step 812, server system 110 selects a panel 170 of panelists by matching panel criteria 132 of study definition 120 with information, such as behavioral data and/or demographic information, that is tracked and/or received from each of the panelist candidates in panelist pool 160 and included in panelist profiles 136, and identifies panelist device 200 as a member of a relevant panel 170. In some embodiments, panelist candidates may be members of one or more cells, each cell including a plurality of panelists sharing certain demographic or behavioral attributes. In these embodiments, panel criteria 132 from a study request may be matched with one or more cells, such that target context 122 may be sent to all members of the associated cell or cells. Additionally, any new member of an associated cell may be sent target context 122 upon assignment to that cell, allowing for dynamic participation as a panelist becomes eligible for a study. The grouping of panelists into cells allows for implementation of a study in smaller stages, corresponding to the size of each cell.

In the example of FIG. 8, server system 110 determined that panelist computing device 200 was a match to panel criteria 132 and was selected for inclusion in panel 160 described above, while in contrast other panelist computing devices may not have been determined to be a match, and thus may not have been selected to join panel 170 described above. Upon matching, server system 110 sends target context 122 to the study client program 138 of selected panelist device 200 in step 814 so that, as shown in step 816, the study client program 138 of panelist device 200 can be configured to monitor browser events to determine if the target context 122 has been met.

In step 818, panelist device 200 requests a web page from third-party server 280, and subsequently receives the requested web page from third-party server 280 at step 820. This event may be in response to a panelist query and may occur within a web page or iFrame of a web page. The panelist device 200 then at step 822 renders the downloaded web page. The panelist device 200 identifies and modifies the DOM of the received web page or iFrame at step 824 in order to monitor browser events in the web page or iFrame, and renders the web page with the modified DOM to display a modified web page in browser 210 of panelist device 200 at step 825. At step 826, a match is detected with the target context 122, so report 142 is sent from the panelist device 200 to the server system 110 at step 828, indicating that the target context 122 has been met. Finally, at step 830, server system 110 sends report 142 to the study generation computing device 150, indicating that a match was found.

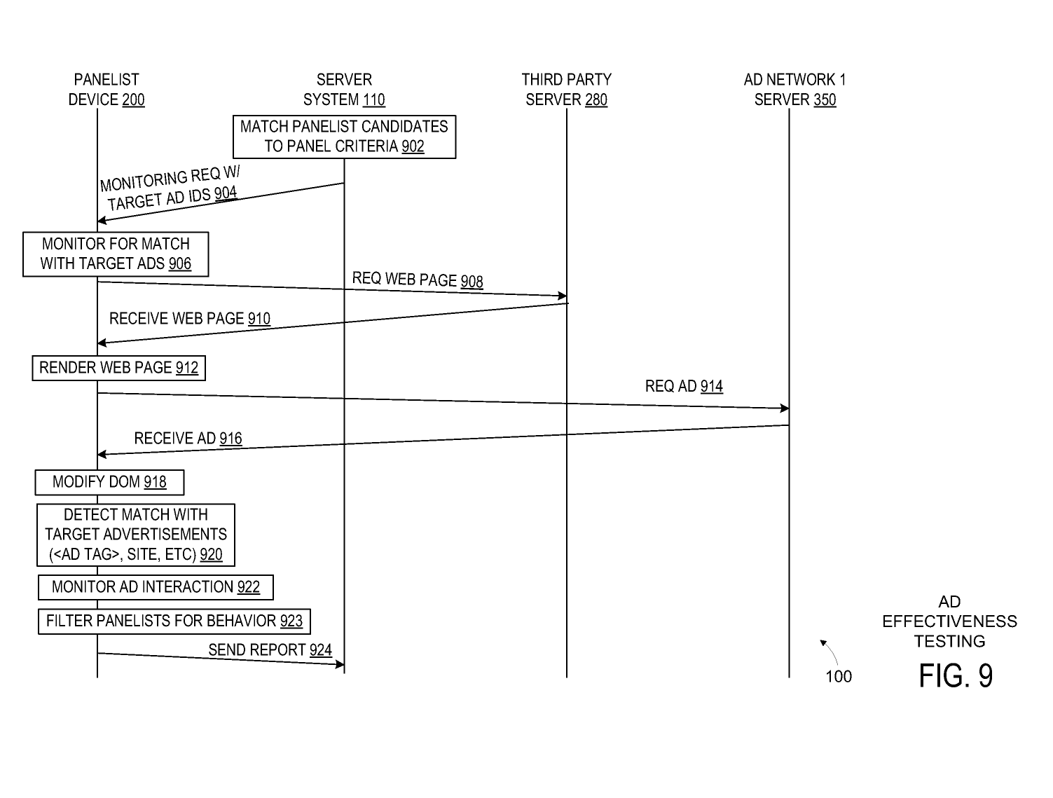

FIG. 9 provides a detailed view of exemplary communications between components of the system 100 used in a first use case scenario in which ad effectiveness is tested, as illustrated in FIG. 3 above. Step 902 occurs after step 810 of FIG. 8, and shows server system 110 matching panelist candidates to panel criteria 132. Server system 110 then sends target context 122 in the form of monitoring requirements including one or more targeted advertisement identifiers to be tracked to panelist computing device 200 at step 904, as panelist computing device 200 is found to match panel criteria 132. At step 906, panelist device 200 monitors for a match with the targeted ad or ads. After panelist device 200 requests and receives a web page from third-party server 280 in steps 908 and 910, respectively, the panelist device 200 then renders the web page in step 912. Panelist device 200 then requests the ad 380 from ad network server 350 in step 914, and receives the ad 380 in step 916, displaying the ad 380 in the associated ad avail 370, as described with respect to FIG. 3. Next, the panelist device 200 modifies the DOM for the web page in step 918 in order to monitor browsing events. Panelist device 200 then determines in step 920 that a targeted ad 380 is found by detecting a relevant ad tag, ad network, web site, etc., that was identified within target context 122 from step 904. Panelist device 200 then monitors interaction with ad 380 at step 922, sending a report 142 to server system 110 at step 924 when it has determined the target context 122 described by the monitoring requirements of step 904 has been met. In some embodiments, the panelists for whom a report is sent at 924 may be filtered at step 923 according to predetermined criteria, so that reports are only sent for panelists matching the filter criteria. In other embodiments, the filtering may be conducted prior to monitoring ad interaction, so that monitoring also only occurs for panelists who match the filter criteria.

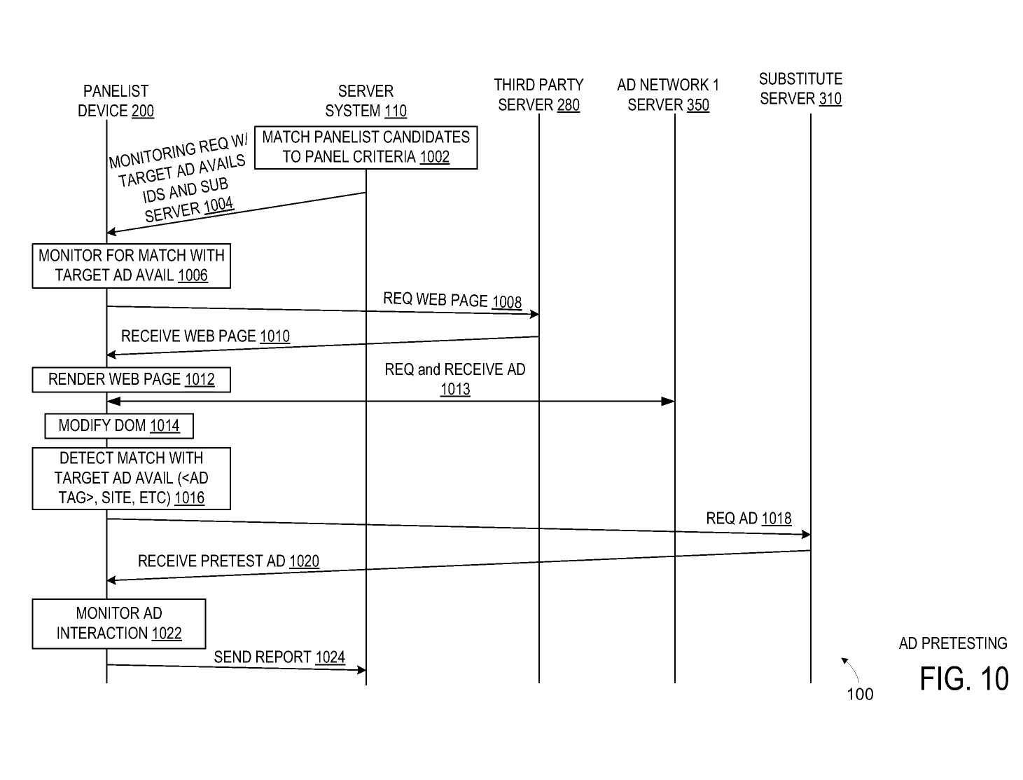

FIG. 10 provides a detailed view of exemplary communications between components of system 100 used in a use case scenario in which an ad is pretested, as described above in FIG. 4. Ad pretesting utilizes a target context 122 in which monitoring requirements include one or more target advertisement avail identifiers that identify ad avails in which a pretest advertisement 400 is to be displayed, as well as one or more substitute server designations (e.g., URLs) which identify network addressable locations on substitute server 310 from which the pretest advertisement 400 may be downloaded. These monitoring requirements are sent from server system 110 to panelist device 200 in step 1004. The panelist computing device 200 begins monitoring for a match with the targeted ad avail in step 1006. As the panelist browses the web, the panelist computing device requests and receives a web page, in steps 1008 and 1010, respectively. At step 1012 the received web page is rendered. The web page may contain a link to an ad served by ad network server 350, and thus at step 1013 an ad may be requested and received from the ad network server, and subsequently rendered on the panelist device 200. At step 1014 the study client on the panelist computing device modifies the DOM, to produce a modified web page with code implemented for detecting a match with a targeted ad avail. The modified DOM will cause code to be executed that, at step 1016, detects whether a target ad avail was contained on the web page, and if so will rewrite the page such that the target ad avail includes a link to a pretest advertisement 400 on a substitute server 310.

After detecting a match with a targeted ad avail in step 1016, the panelist device sends a request for the pretest advertisement 400 to the substitute server 310 in step 1018 in order to retrieve the pretest advertisement 400. When the pretest ad 400 is received at 1020, panelist device 200 inserts the received pretest ad 400 into the associated ad avail 370, as described with respect to FIG. 4, thereby displaying the pretest advertisement 400 in the advertising avail 370 in which the advertisement 380 retrieved from the ad network server 350 was originally displayed. As with the previous embodiment, panelist device 200 monitors ad interaction at step 1022 and sends a report 142 to server system 110 at step 1024 when it has determined a target context 122 described by the monitoring requirements of step 1004 has been met. As described above, it will be appreciated that pretest advertisement 400 may alternatively be displayed in a newly created ad avail on the web page, and thus may not replace the ad retrieved from ad network server 350, but rather be displayed concurrently therewith.

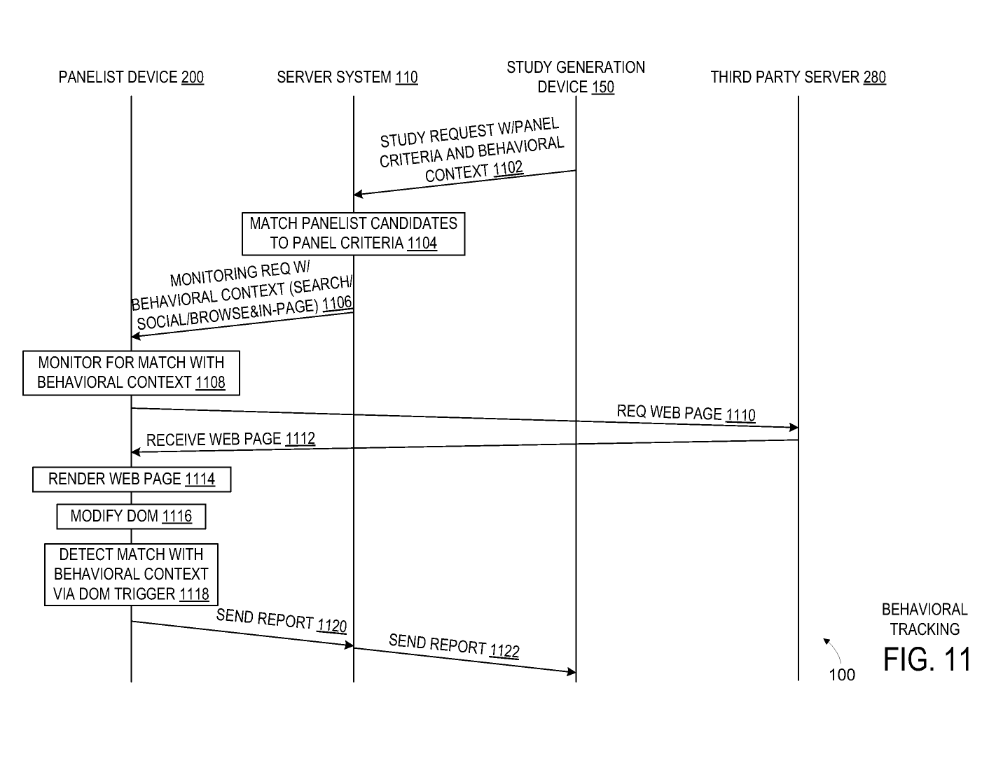

FIG. 11 provides a detailed view of exemplary communications between components of the system 100 used in a use case scenario in which panelist behaviors are tracked, as described above in FIG. 5. In step 1102, study generation computing device 150 provides target context 122 in the form of behavioral context that includes panelist behavior to be tracked. Upon matching panelist candidates to panel criteria 132 at the server system 110 in step 1104, server system 110 passes the monitoring requirements including behavioral context to panelist device 200 in step 1106. Panelist device 200 then monitors accordingly in step 1108, and while a user browses the web, requests and receives a web page from a third party server in steps 1110 and 1112. Upon receiving the web page from the third party server, the panelist device 200 renders the web page, and subsequently modifies the DOM of the received web page in step 1116, to enable code to be executed that detects whether a match exists with the behavioral context. When panelist device 200 detects a match with the behavioral context at step 1118, a report 142 is sent from panelist device 200 to server system 110 at step 1120, indicating that the target context 122 has been met. The report may also contain details on the user behaviors tracked at the panelist device, which may be added to a panelist's profile at the server study system 110.

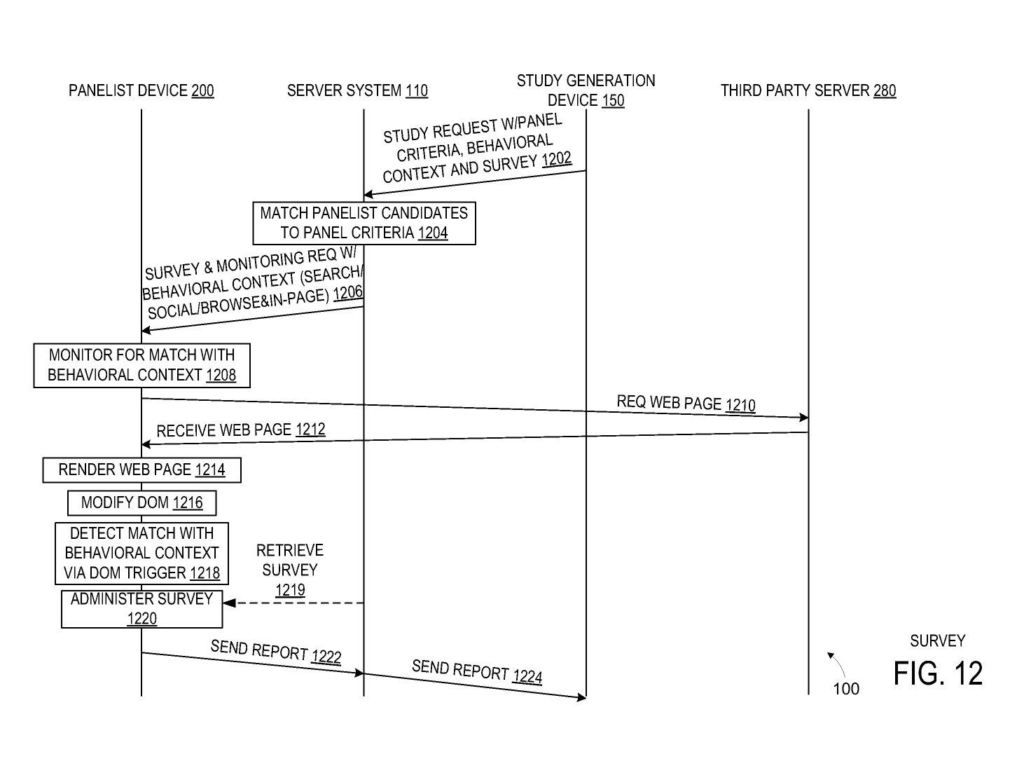

FIG. 12 provides a detailed view of exemplary communications between components of the system 100 used in a use case scenario in which a survey 610 is administered. The target context 122 provided in this embodiment at step 1202 is shown to be a behavioral context, however as described above the target context 122 may, if desired, include criteria related to ad effectiveness testing and ad pretesting as well as behavioral monitoring, as described above. Thus, the communication flows from FIGS. 9-12 may be combined in various subcombinations as desired to implement a particular study.

In step 1202, the study generation device 150 sends a study request with panel criteria behavioral context, and a survey 610, to the server system 110, to commence a survey. At step 1204, the study server system 110 matches candidates to the panel criteria received from the study generation device. At step 1206, the survey and corresponding monitoring requirements (with a behavioral context such as a target search query, social network action, browser action, and/or in-page browsing activity) are sent to study client program 138 of panelist device 200. Alternatively, it will be appreciated that the survey could be stored or generated in server system 110 or an alternative server system or device, and could be sent to panelist device at an alternative time, such as after meeting some predetermined context. Thus for example, the survey may be retrieved at step 1219 if desired.

Returning to step 1214, the panelist device renders the web page, and at step 1216, the panelist device modifies the DOM to cause code to be executed that determines whether a match is detected between the target behavioral context and the user behaviors when browsing the web page.

Upon detecting that the behavioral context is matched at 1218, a survey is administered at 1220. As shown in step 1220, the survey is administered to be completed by the panelist after determining the target context 122 has been met, and a report 142 indicating this event and/or responses to the survey is sent from panelist device 200 to server system 110 in step 1222. Server system 110 may also send report 142 to study generation computing device 150, as shown in step 1224.

The above described systems and methods may be employed to administer a computerized, context-based study, in which participants may be chosen to form a panel. The resulting panelists may be monitored in order to provide a detailed report indicating browsing events of the panelists that are relevant to the study, which provides information to enable accurate evaluations of advertisements and targeted advertisement development.

The various computing devices described herein typically include one or more processors (e.g., single or multi-core CPU, ASIC, controller, system on a chip, etc.) and associated volatile memory (e.g., RAM), along with an associated non-volatile mass storage device (e.g., hard drive, FLASH drive, etc.) which stores programs. The stored programs are executed by the processor using portions of memory to thereby implement the functionalities of the systems and method described herein. The computing devices described herein may take the form of personal computers, mobile computers, server computers, smart phones, laptops, gaming consoles, etc., as appropriate. The computing devices are configured to communicate with each other via computer networks, such as the Internet. Each computing device typically also includes input devices, such as a keyboard, mouse, trackpad, touchscreen, etc., for receiving user input to the programs executed thereon, and an associated display for displaying the output of these programs.

It will be appreciated that media, such as a FLASH® memory drive, DVD, CD, etc. may be provided that includes stored instructions, which, upon execution by a processor of a computing device, cause the computing device to implement the various method described herein. The media, like the non-volatile mass storage described above, is configured to hold the instructions for the programs in a non-volatile, non-transitory manner.

The terms “module,” “program,” and “engine” are used to describe software of the above described systems that is implemented to perform one or more particular functions. In some cases, such a module, program, or engine may be instantiated via a processor executing instructions held by memory, as described above. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for administering a computerized study to a plurality of panelists, the method comprising:
selecting a panel of panelists by matching panel criteria for a study with demographic information received from each of a pool of panelist candidates via respective panelist computing devices;
for each selected panelist in the panel, sending from a server system to a study client program on the associated panelist computing device a target context, the study client program being a browser extension configured to monitor browser events to determine if the target context has been met;
receiving from the panelist computing device a report indicating that the target context has been met.

2. The method of claim 1, further comprising:
during a registration phase, registering a plurality of panelist candidates having associated panelist computing devices;
receiving demographic information for each panelist candidate from the associated panelist computing devices; and
sending the study client program to be installed on each panelist computing device.

3. The method of claim 1, further comprising:
receiving a study definition from a study generation device, the study definition including panel criteria and a target context.

4. The method of claim 3, wherein the target context includes identifiers for advertisements to be tracked.

5. The method of claim 3, wherein the target context includes an identifier for a target advertisement to be replaced with a pretest advertisement, and a designation for a substitute server to which identified advertisement requests for the target advertisement will be redirected in order to retrieve the pretest advertisement from the substitute server and display the pretest advertisement in an advertising avail in which the target advertisement was to be displayed.

6. The method of claim 1, wherein the target context comprises panelist behavior to be tracked.

7. The method of claim 6, wherein the tracked panelist behavior includes search query, social network action, browser navigation, and/or in-page behavior.

8. The method of claim 1, further comprising:
sending, to the browser extension of the panelist computing device, a survey to be completed by the panelist if the target context has been met; and
receiving from the panelist computing device a report indicating responses to the survey.

9. The method of claim 1, further comprising:
sending instructions to the panelist computing device, the instructions causing the client survey program of the panelist computing device to:
identify a document object model (DOM) of a web page or iFrame in response to a panelist query;
modify the DOM in order to monitor browser events in the web page or iFrame; and
render the modified DOM in a browser of the panelist computing device.

10. The method of claim 1, further comprising:
displaying, on a display device of a panelist computing device, a user interface console for the browser extension within a window of a browser.

11. A method for participating in a computerized study with a plurality of panelists, the method comprising:
installing a study client program on a panelist computing device, the study client program being a browser extension configured to monitor browser events;
receiving from a server system a target context, the target context including browser events to be detected by the study client program of the panelist computing device;
detecting, by the study client program of the panelist computing device, that the target context has been met; and
sending to the server system a report indicating that the target context has been met.

12. The method of claim 11, further comprising:
during a registration phase, requesting a registration of a panelist candidate having an associated panelist computing device;
sending demographic information for the panelist candidate from the associated panelist computing device; and
receiving at the panelist computing device the study client program to be installed on the panelist computing device.

13. The method of claim 11, wherein the target context includes identifiers for advertisements to be tracked; and the method further comprising:
determining that the target context has been met if all browser events identified in the target context are detected by the study client program of the panelist computing device.

14. The method of claim 11, wherein the target context includes an identifier for a target advertisement to be replaced with a pretest advertisement and a designation for a substitute server from which the pretest advertisement will be retrieved, the method further comprising:
detecting, by the study client program of the panelist computing device, a browser event comprising a request for a target advertisement;
sending, by the study client program of the panelist computing device, the request for the advertisement to the substitute server designated by the target context in order to retrieve the pretest advertisement;
receiving, from the substitute server, the pretest advertisement;
displaying, on a display device of the panelist computing device, the pretest advertisement in an advertising avail in which the target advertisement was to be displayed;
monitoring, by the study client program of the panelist computing device, browsing events after the pretest advertisement is displayed; and
determining that the target context has been met when the pretest advertisement is displayed and browser events corresponding to the target context are detected.

15. The method of claim 11, wherein the target context comprises panelist behavior to be tracked.

16. The method of claim 6, wherein the tracked panelist behavior includes search query, social network action, browser navigation, and/or in-page behavior

17. The method of claim 11, further comprising:
receiving, by the study client program of the panelist computing device, a survey to be completed by the panelist if the target context has been met; and
sending, to the server system, a report indicating responses to the survey.

18. The method of claim 11, further comprising:
receiving, by the panelist computing device, instructions, the instructions causing the study client program of the panelist computing device to:
identify a document object model (DOM) of a web page or iFrame;
modify the DOM in order to monitor browser events in the web page or iFrame
render the modified DOM in a browser of the panelist computing device.

19. The method of claim 11, further comprising:
displaying, by a display device of the panelist computing device, a user interface console for the study client program within a window of a browser.

20. A method for administering a computerized context-based study to a panel, comprising:
at a server system, during a registration phase of the study,
registering a plurality of panelist candidates having associated panelist computing devices;
receiving demographic information for each panelist candidate from the associated panelist computing devices;
sending to each panelist computing device a study client program, the study client program being a browser extension;
at the server system, during a study generation phase,
receiving a study definition from a study generation device, the study definition including panel criteria and a target context;
at the server system, during a study implementation phase,
selecting a panel of panelist candidates by matching the panel criteria with the panelist candidate demographic information;
for each selected panelist in the panel, sending from the server system to the browser extension on the associated panelist computing device the target context;
at the panelist computing device, receiving from the server system the target context having one or more contextual factors;
monitoring browser events via the study client browser extension to determine if target context has been met;
upon determining that the target context has been met, sending a report to the server system indicating that the target context has been met;
receiving from the panelist computing device the report indicating that the target has been met.
